(19) United States
(12) Patent Application Publication
(10) Pub. No.: US 2004/0193748 A1
(43) Pub. Date: Sep. 30, 2004

(54) Computer readable recording medium recording control program executed in client that transmits print job to printing apparatus via server and the printing apparatus

(75) Inventor: Tetsuya Sugimoto, Muko-Shi (JP)

Correspondence Address: MORRISON & FOERSTER LLP, 1650 TYSONS BOULEVARD, SUITE 300, MCLEAN, VA, 22102, US

(73) Assignee: Minolta Company, Ltd., Osaka (JP)

(21) Appl. No.: 10/607,520

(22) Filed: Jun. 27, 2003

(30) Foreign Application Priority Data
Mar. 28, 2003 (JP) 2003-91712

(51) Int. Cl. G06F 3/00

(52) U.S. Cl. 710/15

(57) ABSTRACT

When a printer driver program is executed in a client PC, an address request command and a network address of the client PC are transmitted to the network printer via a server PC. Thus, the network printer and the client PC can be connected via a network. Then, an IP address of the network printer is received from the network printer via the network. Accordingly, the client PC and the network printer can be connected via the network, using the received IP address.

This application is based on Japanese Patent Application No. 2003-91712 filed with Japan Patent Office on Mar. 28, 2003, the entire content of which is hereby incorporated by reference.

### BACKGROUND OF THE INVENTION

1. Field of the Invention

The present invention relates to a computer readable recording medium recording a control program and a printing apparatus, and specifically, to a computer readable recording medium recording a control program executed in client that transmits a print job to a printing apparatus via a server and the printing apparatus.

2. Description of the Related Art

For sharing a printer among a plurality of computers, a network is used. Employed connection mode is to connect the plurality of computers to the network and to designate one of the computers as a server to which the printer is connected. When the printer and the server are connected, they may be connected through the network, or they may be directly connected to each other with a parallel or a serial interface. The computers other than the server are referred to as clients. In these connection modes, print jobs generated by the clients are transmitted to the server. The print jobs received at the server are output to the printer in order of reception and printed by the printer.

Since the clients transmit the print jobs to the server, the clients and the printer do not communicate directly. Therefore, there is no need for the clients to store the network address of the printer. In the clients, available information related to the printer is limited to the information that can be obtained from the server defined by a print protocol.

Japanese Laid-Open Patent Publication No. 2000-29653 describes an information processing system for notifying of an error occurred at a printer in the course of executing a print job to a client that has transmitted the print job. In the information processing system, when a computer issues a print job to a printer connected to a network, a unique identification number is added to a job header in the print job indicating the transmitter thereof, which is analyzed and held by the printer: When any problem arises at the printer during processing the job, a message is sent to the transmitter of the job using the identification number.

The information processing system described in Japanese Laid-Open Patent Publication No. 2000-29653, however, involves a problem that it can only receive the information of an error related to a print job transmitted by a computer, and it can not obtain any other information from the printer.

It is possible to connect the clients and the printer directly in order for the client to receive information directly. However, it requires a user of the clients to know the IP address of the printer. In order to obtain the IP address of the printer, the user must investigate the network address of the printer on his/her own or must inquire of a network administrator about it, and hence, it can not be obtained without difficulty.

### SUMMARY OF THE INVENTION

The present invention is directed to solve the problem above, and one object of the present invention is to provide a computer readable recording medium recording a control program that causes a client, which transmits a print job to a printing apparatus via a server, to obtain information related to the printing apparatus, and the printing apparatus.

In order to achieve the above object, according to one aspect of the present invention, a computer readable recording medium is provided, which records a control program executed in a client connected via a network to a server connected to a printing apparatus. The control program causes the client to execute steps of: transmitting an address request command for requesting a network address of the printing apparatus and a network address of the client to the printing apparatus via the server; and receiving the network address of the printing apparatus transmitted from the printing apparatus via the network in response to the transmission of the address request command.

According to the present invention, when the control program is executed in the client, the address request command for requesting a network address of the printing apparatus and the network address of the client is transmitted to the printing apparatus via the server. Thus, the printing apparatus receives the network address of the client, and enabled to connect to the client via the network. Then the network address of the printing apparatus transmitted from the printing apparatus via the network is received. Accordingly, the client may be connected to the printing apparatus via the network using thus received address. As a result, the computer readable recording medium recording the control program that causes the client, which transmits a print job to the printing apparatus via the server, to obtain information related to the printing apparatus can be provided.

According to another aspect of the present invention, a printing apparatus connected to a network and provided to an environment of the network through a server is provided. The printing apparatus includes a storage unit to store a network address allocated to the printing apparatus on the network; an input portion to input data from the server; a determination portion to determine whether the input data is a print job; and a transmission portion to transmit, when the determination unit determines that the input data is not a print job, the network address of the printing apparatus to a client specified by a network address included in the input data via the network.

According to the present invention, the network address allocated to the printing apparatus on the network is stored, and when the data input from the server is determined not to be a print job, the network address of the printing apparatus is transmitted via the network to the client specified by the network address included in the data. Accordingly, the client received the network address of the printing apparatus may establish a connection with the printing apparatus via the network using that network address. As a result, the printing apparatus capable of directly transmitting to the client, which transmits a print job to the printing apparatus via the server, information of the printing apparatus via the network can be provided.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 shows an overview of a printing system according to one embodiment of the present invention.

FIG. 2 is a functional block diagram showing functions of a client PC and a network printer.

FIG. 3 is a flowchart indicating flows of processes executed in a printing system according to the present embodiment.

FIG. 4 shows one example of a setting screen.

### DESCRIPTION OF THE PREFERRED EMBODIMENTS

In the following, embodiments of the present invention will be described referring to the figures. In the following description, identical parts are given an identical character. Their names and functions are also the same. Therefore, detailed description thereof is not repeated.

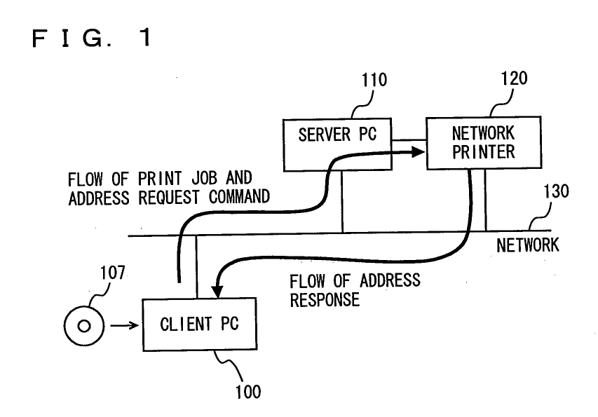

FIG. 1 is an overview of a printing system according to one embodiment of the present invention. Referring to FIG. 1, the printing system includes a personal computer that is a client (hereinafter referred to as “client PC”) 100, a personal computer that is a server (hereinafter referred to as “server PC”) 110, and a network printer 120. Client PC 100, server PC 110, and network printer 120 are connected to a network 130. Network 130 is a local area network (LAN). Therefore, client PC 100, server PC 110, and network printer 120 can communicate with each other according to TCP/IP (Transmission Control Protocol/Internet Protocol). In other words, by designating the IP address of the device to be connected, a network connection can be established.

Server PC 110 and network printer 120 are directly connected to each other with a serial interface or a parallel interface. It should be noted that this direct connection is not necessarily required, and server PC 110 and network printer 120 may be connected in any mode, e.g., via network 130.

Network printer 120 is administered by server PC 110. Therefore, network printer 120 normally receives a print job from server PC 110 and prints it out.

In client PC 100, printer driver software for transmitting a print job to network printer 120 is executed. Client PC 100 includes an external storage device, and reads a printer driver program that is a control program recorded in a recording medium 107, and executes thus read printer driver program by a central processing unit (CPU) accommodated in client PC 100. Generally, such a printer driver program is delivered as recorded in recording medium 107. Then it is read by the external storage device included in client PC 100, and stored in a hard disc in client PC 100 in a non-volatile manner. Client PC 100 reads the printer driver program stored in the hard disc into a random access memory (RAM) and executes it by CPU. Thus, a printer driver function is formed in client PC 100. A hardware configuration and an operation of client PC 100 is well known, thus detailed description thereof is not repeated.

As for recording medium 107, CD-ROM (Compact Disc Read Only Memory), an FD (Flexible Disc), a hard disc, a magnetic tape, a cassette tape, an optical disc (an MO (Magnetic Optical Disc)/an MD (Mini Disc)/a DVD (Digital Versatile Disc)), an IC card (including a memory card), an optic card, and a semiconductor memory such as a mask ROM, an EPROM, an EEPROM, a flash ROM.

The printer driver program as used herein represents a concept including not only a program that can be executed directly by CPU of client PC 100 but also a program of a source program format, a compressed program, or an encrypted program.

Though FIG. 1 shows an example where only one client PC 100 is present, a plurality of client PC can be included, which may not be limited to personal computers and may be workstations as long as they are connected to network 130.

In the printing system according to the present embodiment, a print job from client PC 100 is transmitted to a network printer 120 via server PC 110. Accordingly, there is no need for client PC 100 to store the address of network printer 120 on the network. This is because network printer 120 is administered by server PC 110, and hence client PC 100 and network printer 120 do not need to communicate with each other directly.

In the printing system according to the present embodiment, an address request command for requesting the network address of network printer 120 is transmitted from client PC 100 using the same protocol as in the transmission of a print job from client PC to server PC 110. On reception of the address request command, network printer 120 establishes a connection via network 130 between client PC 100 that has transmitted the address request command, and transmits the network address (IP address) of network printer 120 to client PC 100.

As the network address of network printer 120 is obtained by client PC 100, client PC 100 and network printer 120 are enabled to communicate directly with each other. Thus, client PC may obtain information related to network printer 120 other than those defined by the print protocol directly from network printer 120. For example, as client PC 100 receives information of an operating condition of network printer 120, client PC 100 itself can administer network printer 120. Further, information that can be directly obtained by client PC 100 from network printer 120 in addition to the operating condition includes, for example, a condition of optional equipment attached to network printer 120, size of papers set in network printer 120, remaining amount of papers per size, remaining amount of toner, the number of prints to be output from network printer 120, setting information of network printer 120 on network 130, information related to print default setting, and a network identifier other than IP address allocated to network printer 120 (for example, MAC address).

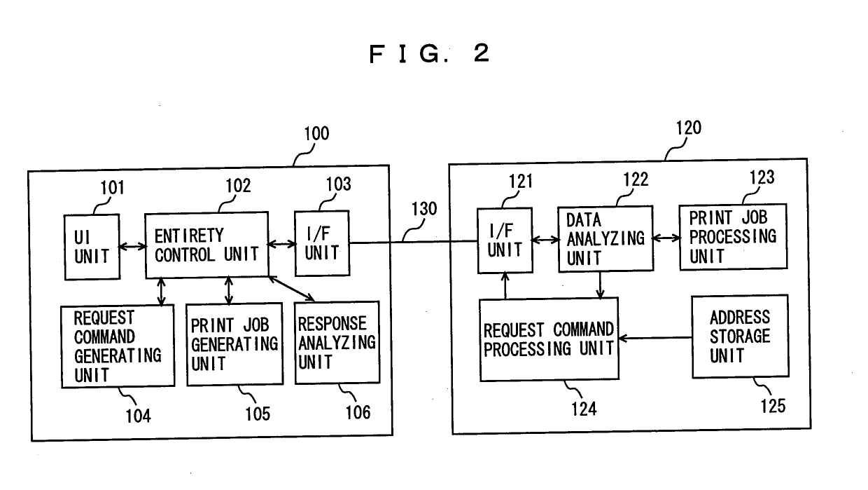

FIG. 2 is a functional block diagram showing functions of client PC 100 and network printer 120. Referring to FIG. 2, client PC 100 includes an entirety control unit 102 for controlling the entire process executed in client PC 100, user interface (UI) unit 101, interface (I/F) unit 103 for connecting client PC 100 to a network, a request command generating unit 104, a print job generating unit 105, and a response analyzing unit 106. Entirety control unit 102, request command generating unit 104, print job generating unit 105, and response analyzing unit 106 are the functions realized by the execution of the printer driver software described above by CPU.

UI unit 101 includes a display such as a liquid crystal display apparatus, a plasma display panel, a cathode-ray tube (CRT), and an input device such as a keyboard or a mouse. Further, UI unit 101 may be arranged by combining a crystal display apparatus and a touch panel made of a transparent member. I/F unit 103 is an interface for connecting client PC 100 to network 130.

Print job generating unit 105 generates a print job for outputting to network printer 120, based on data output from application software executed in client PC 100. Entirety control unit 102 outputs the print job to I/F unit 103 in order to transmit the print job generated by print job generating unit 105 to network printer 120. At this time, as described above, since the print job is transmitted from client PC 100 to network printer 120 via server PC 110, I/F unit 103 outputs the print job to server PC 110.

Request command generating unit 104 generates an address request command for transmitting to network printer 120 in accordance with the operation of a user with UI unit 101. The address request command is for requesting network printer 120 to transmit its IP address.

Thus generated address request command is transmitted from entirety control unit 102. Entirety control unit 102 outputs thus generated address request command, the IP address of the client PC, and the port number to I/F unit 103 in order to transmit them to network printer 120 via server PC 110. The IP address of client PC is an IP address on network 130 that has been allocated to the client PC in advance. The port number is for specifying a program for passing received data and used according to TCP (Transmission Control Protocol) and UDP (User Datagram Protocol). At this step, a number specifying the program for obtaining the IP address of the printer (e.g., a printer driver) may be set. In practice, the free number that is not regularly used may be employed and set. These data output from I/F unit 103 is transmitted by the same protocol as the transmission protocol of the print job as described above. Therefore, I/F unit 103 transmits these data to server PC 110.

Response analyzing unit 106 analyzes the data received at I/F unit 103. I/F unit 103 obtains the port number from the header of the received data and passes data to the program corresponding to the port number. When the IP address is transmitted from printer 120, the port number is determined and the data is passed to response analyzing unit 106 for analyzing the contents of data. Then the network address of network printer 120 included in the received data is stored in RAM or the like included in client PC 100.

Network printer 120 includes an interface (I/F) unit 121 for connecting network printer 120 to network 130, a data analyzing unit 122 for analyzing data received at I/F unit 121, a print job processing unit 123 for processing a print job when data analyzed by data analyzing unit 122 is a print job, a request command processing unit 124 for processing address request command when data analyzed at data analyzing unit 122 is not a print job, and an address storage unit 125 for storing a network address on network 130 allocated to network printer 120.

Though it is not shown, network printer 120 includes an image forming engine for forming an image based on a print data (raster data) that is generated by print job processing unit 123 processing the print job.

When the data received at I/F unit 121 is not a print job, data analyzing unit 122 outputs it to request command processing unit 124. When an address request command is included in the received data, request command processing unit 124 reads a network address from address storage unit 125. It further obtains the IP address and the port number included in the received data, and outputs an instruction to I/F unit 121 for establishing a network connection with client PC 100, using thus obtained IP address and port number. The protocol for establishing the network connection with client PC 100 is determined by TCP/IP, and through the establishment of the network connection, the IP address stored in address storage unit 125 is transmitted to client PC 100.

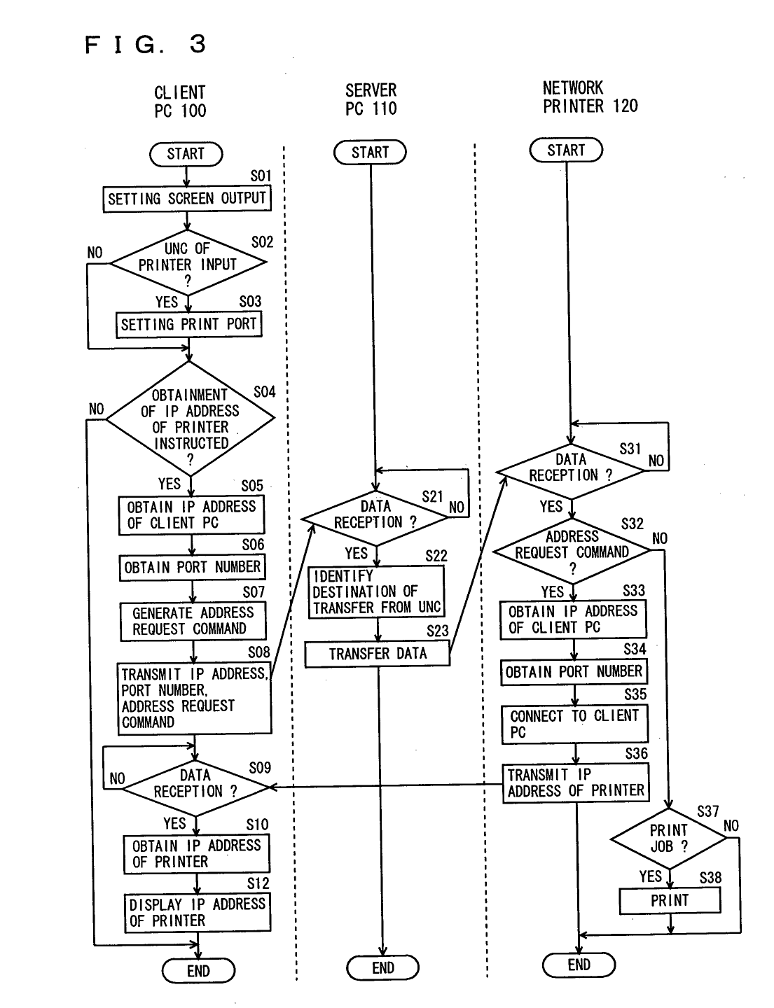

FIG. 3 is a flowchart indicating the flows of processes executed in the printing system according to the present embodiment. In FIG. 3, the processes executed in client PC 100, server PC 110 and network printer 120, respectively, are shown individually. Further, the process executed in client PC 100 is a process executed by CPU of client PC 100 that executes a printer driver program.

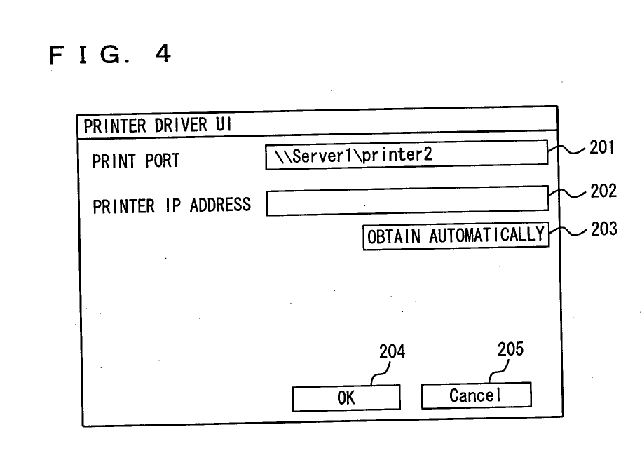

Referring to FIG. 3, a setting screen is output to UI unit 101 (step S01). This setting screen is for setting where to output a print job generated at print job generating unit 105. FIG. 4 shows one example of the setting screen. Referring to FIG. 4, the setting screen includes a region 201 for designating a print port as an output destination of a print job, and an obtainment button 203 with the word “obtain automatically”, an OK button 204 with the word “OK”, a cancellation button 205 with the word “CANCEL”, and a region 202 for displaying the IP address of the printer.

Region 201 is for designating the output destination of print job, and in the present case UNC (Universal Naming Convention) is input. The UNC is structured by combining the server name “Server 1” and the printer name “printer 2”, i.e., “Server1printer2”. The server name “Server1” indicates server PC 110, whereas “printer2” indicates network printer 120. Therefore, by this UNC, a network printer 120 connected to server PC 110 is specified. Region 202 is for displaying the IP address of network printer 120.

Obtainment button 203 is for instructing the transmission of an address request command to network printer 120. Obtainment button 203 is activated by a user operating UI unit 101.

As OK button 204 is activated by the user operating UI unit 101, the UNC input to region 201 is stored in a hard disc or the like in client PC 100. Then, print jobs generated at print job generating unit 105 after this point will be output to the print port specified by that UNC.

Cancellation button 205 is for instructing the cancellation of UNC that has been input to region 201. As cancellation button 205 is activated by the user operating UI unit 101, the setting screen is cleared and UNC that has been input is discarded. As obtainment button 203 is activated by the user operating UI unit 101, a flag for obtaining the IP address of network printer 120 is set.

Referring back to FIG. 3, following step S01 in which the setting screen is output to UI unit 101, when OK button 204 is activated by the user operating UI unit 101, whether UNC of the network printer is input or not is determined (step S02). The determination is made considering if UNC for designating a print port is input to region 201 of the setting screen described above, and also OK button 203 with the word “OK” is activated. When it is determined that there is an input of UNC, the process goes to step S03. Otherwise, the process skips step S03 and goes to step S04. At step S03, the UNC that is input to region 201 is set as the print port.

At step S04, determination is made whether an instruction for obtaining the IP address of the printer is made or not. When the instruction is made, the process goes to step S05, otherwise the process ends. This determination is made considering if obtainment button 203 with the word “obtain automatically” has been activated and the flag above has been set.

Then, the IP address of client PC is obtained (step S05), and the port number is obtained (step S06). The port number indicates the port designated in step S09, which will be described below, in order for client PC 100 to receive information via network 130, and it is predetermined. Note that the port number may be set by the user using the setting screen above.

At step S07, an address request command is generated. In the subsequent step S08, the IP address of client PC 100 obtained at step S05 and the address request command generated at step S07 are output to the print port set at step S03.

The print port set at step S03 is a port designated to normally output the print job generated by print job generating unit 105. Therefore, data output at step S08 is output according to the protocol for transmitting the print job. Thus, the information is output with an address request command attached to its header. Accordingly, network printer 120 receiving the data can determine that the received data is not a print job but it is an address request command.

As above, the print port set at step S03 is specified by UNC, which includes “Server1” for specifying server PC 110 and “printer 2” for specifying network printer 120. Hence, the data output to thus set print port is transmitted to network printer 120 via network 130 and server PC 110.

Following step S08, client PC 100 enters a waiting state until receiving data from network printer 120 (Step S09).

In server PC 110, whether data is received or not is determined (step S21), and when the data is received, the process goes to step S22. At step S22, the destination is determined by UNC included in the received data. Specifically, since “Server1printer2” is employed as UNC in the present embodiment, network printer 120 specified by “printer2” is identified as the destination. Then the received data is output to network printer 120 thus identified to be the destination (step S23).

In network printer 120, whether data is received from server PC 110 or not is determined (step S31), and when the data is received, the process goes to step S32. At step S32, the header of the received data is analyzed, and whether the data is an address request command or not is determined. When it is determined to be an address request command, the process goes to step S33, and otherwise goes to step S37.

At step S33, the IP address of client PC included in the received data is obtained. Then, in the subsequent step S34, the port number included in the received data is obtained. Thus, network printer 120 can establish a network connection between client PC 100 via network 130.

At step S35, a network connection is established with client PC via network 130, using the IP address of client PC obtained at step S33 and the port number obtained at step S34. Thereafter, the IP address of network printer 120 is transmitted to client PC 100 (step S36).

In network printer 120, at step S37, whether the data received at step S31 is a print job or not is determined. This determination is made by analyzing the header of the received data. When determined to be a print job, then a print process using the print job is executed at step S38.

Thus, the header of the received data is analyzed and the print process is executed when the data is determined to be a print job, whereas the print process is prohibited when it is determined not to be a print job, i.e., the print process using the received address request command, IP address of client PC 100 and data of port number is not executed. Accordingly, the IP address and the port number will not be printed out, avoiding the execution of an unnecessary print process.

In client PC 100, whether data is received from network printer 120 or not is determined (step S09). When the data is received, the process goes to step S1. The determination is based on the header of the data (packet) to the port number set at step S06. Thus, it can be confirmed to be the reception of data from network printer 120 that has transmitted the address request command at step S08.

In the subsequent step S10, the IP address of network printer 120 is obtained from the data received at step S09. Then, thus obtained IP address is displayed in region 202 shown in FIG. 4. Thus, the user of client PC 100 can recognize the IP address of network printer 120.

The user can check the operating condition or change the setting of network printer 120 by inputting thus obtained IP address to the address field of a Web browser, for example.

Though in the present embodiment the IP address has been used for the network address of client PC 100 and network printer 120 on network 130, other addresses such as MAC (Media Access Control) may be used as well, as long as they can be identified on network 130 independently.

Further, though in the present embodiment the port number is transmitted from client PC 100 and the data is received by the port specified by that port number, if the port number for receiving data at client PC 100 is determined in advance and network printer 120 transmits the IP address of the printer to the port specified by that port number, the process for transmitting port number as a content of data can be eliminated. In this case, the process at step S06 is no longer necessary and there is no need to transmit the port number at step S08. Step S34 in the process in network printer 120 is eliminated. At step S36 that is executed by network printer 120, the IP address is transmitted to client PC 100 using the predetermined port number.

Still further, as for network connection establishment between network printer 120 and client PC 100, according to the protocol of TCP/IP, the IP address of network printer 120 requesting connection establishment is transmitted to client PC 100 when the network connection is established (step S35). This is because the IP address of the transmitter is included in the IP header of the packet. Accordingly, client PC 100 may obtain the IP address after network printer 120 requested a network connection to client PC 100 and the connection is completed. In this case, the process at step S36 is eliminated.

Still further, in the present embodiment, the print port to which client PC 100.outputs a print job is designated using UNC. This UNC is structured by a combination of “Server1” specifying server PC 110 and “printer2” specifying network printer 120 connected thereto. Data transmitted from client PC 100 to server PC 110 for specifying network printer 120 may be “Server1printer2”, or “printer2”. It depends on a protocol. In either case, the IP address or MAC address of server PC 110 is specified based on “Server1” of UNC, and “Server1printer2”, or “printer2” is transmitted to server PC 110 as UNC. Therefore, from client PC 100, “Server1printer2” or “printer2” for specifying network printer 120, the IP address and the port number of client PC 100, and the address request command are transmitted to server PC 110 that is specified by the IP address or MAC address. Note that UNC output from client PC 100 to server PC 100 is not limited thereto.

As has been described, in the printing system according to the present embodiment, the address request command output from client PC 100 is provided to the print port that receives a print job, i.e., through the same path as a print job. Accordingly, an improvement is not needed in the communication portion of the printer driver program.

Further, since the IP address and the port number of client PC 100 are transmitted with the address request command, network printer 120 receives the IP address and the port number of client PC 100. As a result, establishment of a network connection between network printer 120 and client PC 100 is enabled. Through the establishment of the network connection, the IP address of network printer 120 is transmitted to client PC 100 from network printer 120, and the IP address of network printer 120 is obtained at client PC 100. As a result, the user of client PC 100 can establish the network connection between client PC 100 and network printer 120 using thus obtained IP address of network printer 120, and hence enabled to obtain various information from network printer 120.

Still further, since the port number is output from client PC 100 which is used to receive the IP address of network printer 120, the reception of the IP address of network printer is ensured.

Still further, since the IP address of network printer 120 is displayed in region 202 of the setting screen by the user just activating obtainment button 203 for instructing the execution of address obtainment through the operation of UI unit 101, the user can recognize the IP address of the network printer as necessary.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A computer readable recording medium recording a control program executed in a client connected via a network to a server connected to a printing apparatus, said control program causing said client to execute steps of:
transmitting an address request command for requesting a network address of said printing apparatus and a network address of said client to said printing apparatus via said server; and
receiving the network address of said printing apparatus transmitted from said printing apparatus via said network in response to the transmission of said address request command.

2. The computer readable recording medium recording the control program according to claim 1, wherein
a port number for specifying said control program is further transmitted in said transmission step.

3. The computer readable recording medium recording the control program according to claim 2, said control program further causes the client to execute
a step of outputting an instruction screen for prompting a user to input an instruction for transmitting said address request command, wherein
said transmission step is executed on condition that said instruction for transmission is input.

4. The computer readable recording medium recording the control program according to claim 3, wherein
an input of information for specifying said printing apparatus is accepted at said instruction screen, said information being in a format including a server name and a printing apparatus name.

5. The computer readable recording medium recording the control program according to claim 1, wherein
said network address is an IP address.

6. A printing apparatus connected to a network and provided to an environment of said network through a server, comprising:
a storage unit to store a network address allocated to said printing apparatus on said network;
an input portion to input data from said server;
a determination portion to determine whether said input data is a print job; and
a transmission portion to transmit, when said determination unit determines that said input data is not a print job, the network address of said printing apparatus to a client specified by a network address included in said input data via said network.

7. The printing apparatus according to claim 6, further comprising:
a prohibition portion to prohibit, when said determination portion determines that said input data is not a print job, printing of said input data.

8. A computer readable recording medium recording a control program executed in a client connected via a network to a server connected to a printing apparatus, said control program causing said client to execute steps of:
generating data for transmitting an address request command for requesting a network address of said printing apparatus and a network address of said client;
transmitting said address request command, said data and a print job to said printing apparatus via said server; and
receiving the network address of said printing apparatus transmitted from said printing apparatus via said network in response to the transmission of said address request command.

9. The computer readable recording medium recording the control program according to claim 8, said control program further causing said client to execute
a step of displaying, in accordance with the reception of said network address, the received network address.

10. The computer readable recording medium recording the control program according to claim 8, said control program further causing said client to execute
a step of setting identification information for specifying said printing apparatus via said server, wherein
said transmission step is executed in accordance with said identification information.

11. The computer readable recording medium recording the control program according to claim 10, said control program further causing said client to execute
a step of displaying the network address of said printing apparatus received at said reception step on a screen for setting said identification information.

12. A printing apparatus connected to a network and provided to an environment of said network through a server, comprising:
a storage unit to store a network address allocated to said printing apparatus on said network;
an input portion to input data from said server;
a determination portion to determine whether said input data is a print job or an address request command; and
a connection establishment portion to establish, when said determination portion determines that said input data is an address request command, a connection with a device specified by a network address included in said address request command via said network, wherein
said determination portion determines based on a header of said input data.

13. A computer readable recording medium recording a printer driver program executed in a computer connected to a network, said printer driver program causes said computer to execute steps of:
accepting specification of a printing apparatus administered by a server;
transmitting an IP address of said computer to said printing apparatus; and
receiving data transmitted from said printing apparatus and obtaining an IP address of said printing apparatus from the received data.

14. The computer readable recording medium recording the printer driver program according to claim 13, wherein
a port number specifying the program is transmitted with the IP address in said transmission step.

15. A printing apparatus connected to a network and provided to an environment of said network through a server, comprising:
a storage unit to store an address for specifying said printing apparatus on said network;
a reception portion to receive data from said server;
an obtainment portion to obtain, when a command requesting a transmission of the address of said printing apparatus is included in the received data, an address of a transmitter of the received data included in the received data; and
a transmission portion to transmit the address of said printing apparatus stored in said storage unit to the obtained address.
